(19) United States
(12) Patent Application Publication
(10) Pub. No.: US 2011/0298619 A1
(43) Pub. Date: Dec. 8, 2011

(54) ANIMAL MONITORING SYSTEM AND METHOD

(75) Inventors: Brendan O'Hare, Newry (GB); Declan O'Hare, Newry (GB); Jonathan Lee, Newry (GB)

(73) Assignee: FAIRE (NI) LIMITED, Newry (GB)

(21) Appl. No.: 13/133,854

(22) PCT Filed: Dec. 10, 2009
(86) PCT No.: PCT/EP2009/008835

§ 371 Date: Aug. 24, 2011

(30) Foreign Application Priority Data
Dec. 11, 2008 (GB) 0822580.7

(51) Int. Cl. G08B 23/00

(52) U.S. Cl. 340/573.1

(57) ABSTRACT

An animal monitoring system, comprising at least one tag attachable to an animal, a real time location system (RTLS) for determining the three dimensional position of said at least one tag within a monitoring zone, orientation determining means for determining the orientation of said at least one tag, and discriminating means for discriminating between different activities of the at least one animal based upon the location and orientation of the animal's tag within the monitoring zone.

This invention relates to a system and method for monitoring animals, such as dairy cattle, in particular for determining animal status, such as health, fertility (oestrous or calving), animal to animal interaction, animal to object and animal to environment interaction.

As livestock systems (e.g. dairy, beef, sheep and pigs) become more intensive, there is a producer need to manage livestock on a larger scale where labour availability, skill and resources are often limited. This means that attention to individual animal health, fertility and effective heat detection are under constant time pressure, resulting in reduced herd performance and productivity and its consequential relative industry losses. Also, an increased need for bio-surveillance in the light of disease outbreaks, e.g. Foot and Mouth Disease (FMD), Bovine Spongiform Encephalopathy (BSE), Bovine Tuberculosis (bTB) etc., means increasing attention on individual animal status. In addition, consumer pressure in terms of food safety and animal welfare means that increasing attention is drawn to tracking animals and monitoring individual animal status, health, feeding and drinking.

It is an object of the invention to provide a system and method which can relieve the producer/vet/owner of at least some of the labour resources hitherto necessary to carry out these activities.

According to the present invention there is provided an animal monitoring system, comprising at least one tag attachable to an animal, a real time location system (RTLS) for determining the three dimensional position of said at least one tag within a monitoring zone, orientation determining means for determining the orientation of said at least one tag, and discriminating means for discriminating between different activities of the at least one animal based upon the location and orientation of the animal's tag within the monitoring zone.

Preferably the system further comprises means for determining the rate of movement of the at least one tag, preferably as a vector.

Preferably the discriminating means discriminates between different activities of at least one animal by comparing the three dimensional location and three dimensional orientation of the animal's tag within the zone with at least one datum in a computer model of the monitoring zone and preferably by determining the rate of movement of the animal's tag. The location of the animal's tag and the datum in the computer model may be defined in three-dimensions such that the monitoring system can determine the relative distance of the animal's tag from the datum in three dimensions. At least one datum may correspond to the position of a fixed object within the monitoring zone, such as a feeding trough or animal cubicle or stall. Alternatively, or additionally, at least one datum may correspond to a particular location or spatial position indicative of the activity of the cow, for example standing or lying down or in a feeding position adjacent a food source, such as a feed trough.

Preferably, the system further discriminates between different activities of at least one animal by comparing the location and orientation and/or rate of movement of the animal's tag within the zone with the location and orientation and/or rate of movement of at least one further tag within the zone, such further tag being associated with a further animal or object within the monitoring zone. The location of the animal's tag and the location of the one or more further tags may be defined in three-dimensions such that the monitoring system can determine the relative distance and orientation/movement of the animal's tag from said at least one further tag in three dimensions.

In the preferred embodiment the monitoring zone comprises a dairy shed.

The at least one further tag could be associated with a person whereby the system may determine and record contact of such person with a particular tagged animal to determine and/or record activities, such as milking or veterinary attention or pregnancy diagnosis.

The at least one further tag may be associated with a mobile device, such as a vehicle, such that the system may provide an alert, for example to the operator of the device, if the proximity and orientation between such further tag and a tag of an animal indicates a certain proximity between the object and animal, for example indicative of a risk of injury to the animal and/or damage to the object.

Preferably the at least one tag comprises an active or passive radio frequency transponder and an orientation sensing/detection device, said RTLS comprising at least one radio frequency transceiver for detecting the location of the or each tag within the monitoring zone. Preferably said RTLS comprises a plurality of radio frequency transceivers whereby the three dimensional location of said at least one tag can be determined by comparing the time taken for receipt of a signal from said at least one tag by at least three of said plurality of transceivers such that the location of the tag can be determined by triangulation techniques.

Preferably the RTLS uses ultra-wideband radio frequency technology to achieve optimum accuracy over distance and high resolution to provide accurate three dimensional positioning of the or each tag within the monitoring zone.

In one embodiment the orientation sensing/detection comprises magneto-resistive field sensors or magneto-inductive sensors and/or one or more accelerometers.

Preferably the or each tag provides a unique identifier for uniquely identifying the animal to which it is attached.

The tag may also be associated with one or more biometric sensors provided on or in or associated with the animal for determining and/or monitoring the physical condition of the animal, such as sensors for sensing the temperature of the animal. The tag may also be associated with one or more environmental sensors for determining and/or monitoring the ambient conditions surrounding the animal, such as temperature, humidity and/or air quality, for example methane, ammonia or other greenhouse a compositions.

In one embodiment the determining means is programmed to generate/trigger alarm means upon determination of a predetermined status or activity of a tagged animal. Preferably said alarm means identifies the tagged animal for which said status of activity is detected, the nature of the status/activity detected and/or the location of the animal.

In one embodiment the tag comprises a collar or neck band adapted to be fitted around the animal's neck. In an alternative embodiment, the tag comprises an ear tag attachable to an animal's ear. Other means for attaching the tag to an animal are envisaged. For example, the tag may be inserted beneath an animal's skin or attached to a suitable harness for attachment around the body of an animal.

The invention further provides a method of monitoring animals comprising individually identifying and tracking the movements of tagged animals and/or objects in three dimensions within a monitoring zone, and discriminating between different activities of at least one animal based upon the location and orientation of the or each animal's and/or object's tag within the zone.

In a further aspect of the present invention there is provided a tag for an animal monitoring system comprising a transponder for determining the three dimensional location of the tag in a monitoring zone and an orientation detection/sensing device for determining the orientation of the tag in three dimensions.

Preferably the tag is adapted to be attachable to an animal. In one embodiment the tag comprises a collar attachable to the neck of an animal.

Preferably the transponder comprises a radio frequency transponder, more preferably an Ultra-wide band transponder.

Preferably the orientation detection/sensing device comprises magneto-resistive field sensors or magneto-inductive sensors and/or one or more accelerometers.

According to a further aspect of the present invention there is provided a tag attachable to an animal, in particular a cow, for use in an animal monitoring system for determining the three dimensional position of the tag within a monitoring zone, said tag comprising a saddle shaped tag housing shaped to be locatable on a spine region of the animal and a strap for attaching the tag housing to the animal.

According to a further aspect of the present invention there is provided an animal monitoring system, comprising at least one tag attachable to an animal, means for determining the position of said at least one tag in at least one of an x, y and z dimension within a monitoring zone, means for determining the orientation and rate of movement of said at least one tag, and discriminating means for discriminating between different activities of the at least one animal based upon the location in said at least one dimension and orientation and rate of movement of the animal's tag within the monitoring zone, preferably with respect to a fixed datum or the position of a further tag within the monitoring zone.

Preferably the system includes means for determining both the orientation and rate of movement of said tag.

An embodiment of the invention will now be described, by way of example, with reference to the accompanying drawings, in which:

FIG. 1 is a perspective view of two animals in a monitoring zone incorporating an animal monitoring system in accordance with an embodiment of the present invention;

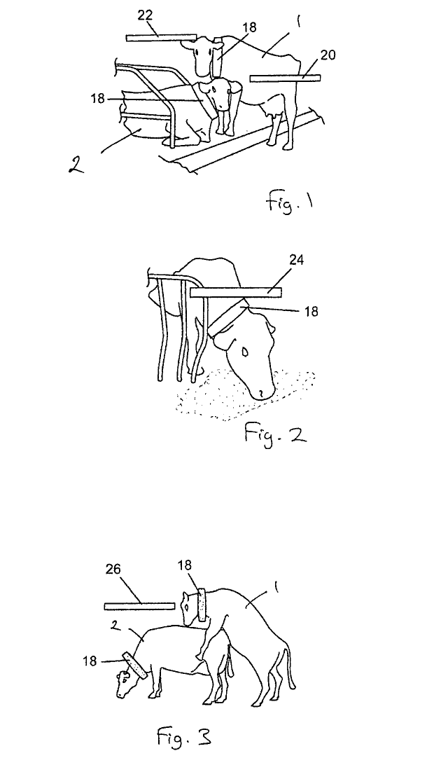

FIG. 2 is a further perspective view of an animal undertaking a different activity within the monitoring zone;

FIG. 3 is a perspective view of an animal mounting another animal within the monitoring zone;

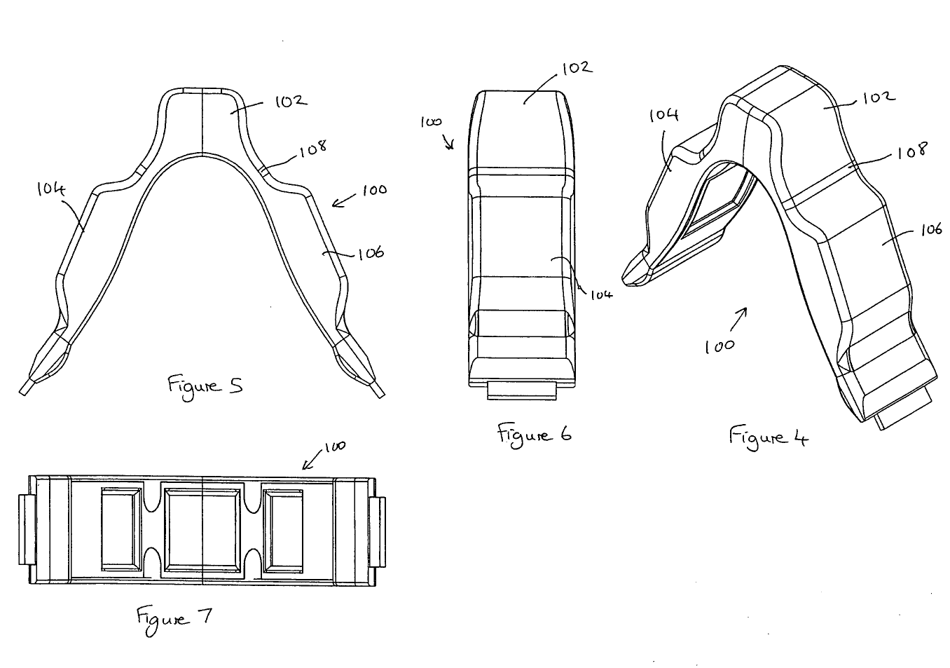

FIG. 4 is a perspective view of a tag housing for use with the animal monitoring system of FIG. 1;

FIG. 5 is a front view of the tag housing of FIG. 4;

FIG. 6 is an end view of the tag housing of FIG. 4; and

FIG. 7 is a plan view of the tag housing of FIG. 4 from below

The drawings show animals, more specifically dairy cattle, within a monitoring zone, such as a cattle shed, undertaking different activities capable of being identified by an animal monitoring system according to an embodiment of the present invention.

The present invention provides a system and method for the continual precision monitoring of animals. The monitoring system according an embodiment of the present invention is applicable to monitoring the health and activity of many different kinds of animals, for example domestic livestock and equine animals, zoo animals, or any other animals kept in a confined monitoring zone. However, the present invention has particular application to the monitoring of cattle.

This system and method allows for precise animal monitoring of;

a) The health, welfare and fertility parameters of an animal within its environment (meaning total area e.g. farm, transportation, animal processing plants, zoos, wildlife parks, stables, kennels, catteries) or zone area (meaning specific area of said environment e.g. passageway area, cubicle area, feeding systems or area, milking systems or area, grassland area, loafing area, access/control/sorting gates, a stable, a paddock);

b) The interaction and behavior of an animal and between different animals to include fertility (oestrous detection, calving), health and welfare;

c) The movement of animals within the environment and respective use/tracking of animal through their zone area.

The system may also define a virtual fencing or animal movement control system whereby the system can monitor the position and orientation of an animal within a monitoring zone and provide an alert or other action base upon such information.

The system is based on utilising real time accurate location technology in combination with orientation detection. This can be active or passive radio frequency transceiver/transponder systems, including all known radio frequency bandwidths (GPS, RFID, UWB etc). However, Ultra Wide Band (UWB) technology is preferred because of its improved accuracy over distance and high resolution in 3 dimensions compared to other locating systems, such as RFID/GPS technologies. Utilising UWB ensures large bandwidth and gives high levels of locating accuracy in three dimensions. Locational accuracy of within 15 cms with 95% confidence level can be achieved using UWB systems, which RFID/GPS systems cannot provide.

Utilising UWB means AOA (angle of arrival) & TDOA (time difference of arrival) calculation techniques ensure high levels of accuracy in all circumstances and especially in metal/steel environments, which RFID/GPS systems cannot perform.

Utilising UWB for the purposes of this application thereby provides high accuracy in 3D mode and the ability for continuous tracking of the animal.

A monitoring system in accordance with an embodiment of the present invention comprises a tag 18 applied to each animal and also possibly to other objects, particularly moveable objects, within a monitoring zone. This could be applied to existing neckbands or ear-tags or by any other means practically defined. Each tag 18 contains a UWB transponder for determining the position of the tag and an orientation or compass indicator device for determining the orientation and/or the rate of movement of the tag.

In the present embodiment the RTLS comprises four ultrawideband (UWB) transceivers mounted at the corners of the shed. The particular number and placement of the transceivers will depend on the size and shape of the dairy shed or other zone being monitored.

In use of the system the location of each tag 18 in three-dimensions within the dairy shed is tracked using multilateration techniques, for example using Time Difference of Arrival (TDOA) and Received Signal Strength Indicator (RSSI) techniques. To this end the raw data from the transceivers is supplied to an associated data processing system to determine, on an ongoing basis, the instantaneous 3D position of each tag in the shed. UWB technology is used since it provides a long range and high accuracy, allowing the position of each tag to be determined to a high degree of accuracy. The signal emitted by each tag and detected by the transceivers not only allows the instantaneous location of the tag to be determined but also returns an ID unique to the animal bearing the tag and may allow determination of the rate of movement of the tag

An important feature of the present invention is the provision of an orientation sensing/detection device within each tag 18 which allows the orientation as well of the position of each animal and/or object with respect to its environment to be determined. Such orientation sensing/detection device may also determine the rate of movement of the tag, preferably as a vector quantity.

In one embodiment, the orientation device measures the magnetic direction (from the earth's magnetic field) by using magneto resistive field sensors or magneto-inductive sensors. These sensors are made of permalloy (NIFE) films that create a variable resistivity as a result of external magnetic forces. These films create a 3-dimensional picture of the earth's magnetic field and can calculate the direction of the device from magnetic north. By determining the magnetic field in three dimensions, the device can compensate for any tilting of the device.

Additionally, or alternatively, the pitch & roll of the device can be measured with the use of accelerometers. Accelerometers measure the direction of the earth's gravitational pull upon the orientation device, and with simple trigonometry the pitch & roll is determined. Accelerometers may also determine the rate of movement of the tag.

Preferably the tag incorporates a three axis accelerometer to determine the rate of motion of the tag in three dimensions. The accelerometer may determine the motion of the cow and may be used to detect abnormal motion or motion indicative of a specific animal condition, such as oestrous.

The three dimensional position of the animal's tag within the monitoring zone may be used to activate the accelerometer to provide further data regarding the activity and/or condition of the animal at certain locations. Alternatively, or additionally, the accelerometer may be utilised to trigger the RTLS functionality in terms of the position and/or orientation monitoring of the animal. For example, to reduce power consumption the RTLS functionality of the tag may be deactivated when the cow has been immobile for a period of time, for example when sleeping, and may be reactivated upon detection of movement of the animal by the accelerometer or when acceleration beyond a certain threshold is detected. The data from the accelerometer may also be used to adjust the sampling frequency of the RTLS system. For example, a sudden vertical acceleration of the tag may trigger an increased sampling frequency of the RTLS system.

The acceleration data from the accelerometer may increase the positional accuracy of the RTLS system. The acceleration data, preferably along with the orientation data, may also be used to determine the position of the animal should the animal move outside of the range of the RTLS system.

Each tag may also uniquely identify the individual animal or object to which it is attached.

The tag thereby allows for high accuracy three dimensional positioning and directional monitoring of a tagged animal, continuously in real time.

The tag 18 may also be associated with one or more biometric sensors for determining the physical condition of the animal. Such sensors may monitor, for example, the animal's temperature, or may hormonal or metabolite changes in the animal and/or enable DNA sequencing/identification of the animal. The tag may also be associated with environmental sensors for sensing environmental conditions, such as ambient temperature, humidity and or gas levels/concentrations. Such as analysis may measure levels of greenhouse gases, such as methane and ammonia. Such information may be uilised to determine the carbon footprint of a cow. Visual sensors, such as a still or video camera may also be mounted on the animal to be monitored by the system.

Each tag may be provided with additional wireless, infra-red or other suitable communications means to enable communication between tags and/or suitable receivers/transceivers located within the monitoring zone or at gate/fence entry and exit points or other systems, such as milking or feeding facilities, or between a tag and a mobile device, such as a handheld receiver/tag interrogation device.

A sensor receiver system is positioned around the environment with accompanying software/server for data retrieval.

The system can be set up within any environment or zone area that is outdoors or indoors.

The system is programmed with a three dimensional model of the animal's environment, which can be created using known Computer Aided Design techniques. Such model may include the three dimensional location of all key fixed features located in the animal's environment, such as feed troughs, animal stalls or cubicles etc. Mobile objects within the animal's environment may be associated with further tags so that the position and also preferably the orientation of such objects can be determined.

Defined computer datums based on 3D coordinates X (horizontal), Y(longitudinal) Z(height) and orientation may then be incorporated as spatial algorithms which will act as alarms, triggers of certain individual animal activity or animal to animal interaction or animal to zone area interaction. The system can therefore define a virtual enclosure and may be used to monitor and/or control the movement of individual animals within the monitored zone.

The RTLS system and tag identification may be used to control the operation of gates to control the access of the animal to certain locations within or outside of the monitoring zone based upon the identity and/or activity and/or condition of the animal.

As shown in FIG. 1, an animal lying down is defined as a z (height) datum 20 which corresponds to the height of that animal at that particular zone and her orientation.

Datum points within the model may comprise the X,Y coordinate of the cubicle in the pre-set 3D model of the animals environment. As shown in FIG. 1, cow 2 is defined to be lying in this zone as her z datum is at a certain preset z datum 20. Cow 2 in this diagram is in fact facing the wrong way and this would be detected by the orientation datum.

FIG. 1 also shows an animal standing (cow 1) which is defined as a z datum 22 corresponding to the height of the standing animal within this specific zone (i.e. animal standing inside the cubicle). A second or number of z height datums can then be defined per individual animal which corresponds to the animal standing in the passageway or at different height levels within the environment or zone areas.

The orientation of the individual animal at any position within the environment or specific zone areas can also be defined.

FIG. 2 is one example of this and shows the orientation and position of an animal at a feeding bunk whereby the z height datum 24 is defined (i.e. the head is at the right position and height to access feed and that she is facing the right way to access the feed).

FIG. 3 is an animal mounting another animal (i.e. exhibiting signs of oestrous or heat, an important fertility behavior). Here a z height datum 26 is pre-set at a height corresponding to the animal standing (cow 1). An animal rising above this z datum is detected when it crosses the z datum height 26 of the first animal. The data from the accelerometer may also be used to determine the activity of the animal.

Orientation of the two animals is then confirmed and an alarm is elicited providing location, time and identification of the two animals involved (cow 1 being the animal in oestrous and cow 2 a possible pre-oestrous animal). An animal's orientation can also be used in this instance to establish a head mounting animal. If this is the case then cow 2 is the animal in oestrous. Circular movements and chin resting activity can also be detected by this means as indicative of an animal in oestrous.

An animal showing signs of giving birth; an animal eliciting activity at a time period close to expected birthing date and/or in the birthing zone area of the environment sets a trigger off based on pre-defined datums for that individual animal: i.e. Z height and orientation datum show certain characteristics: namely circular movements, lying down, standing up. Such defined datum characteristics will elicit an alarm for attention to be made to the individual animal based on user defined time criteria.

An animal in a passageway zone (pre-defined in CAD environment set up) and below a pre-set z datum height for a pre-set time criteria is likely to be injured. Such a datum will elicit an alarm for attention to the animal.

An animal that is lame will elicit an alarm based on datum coordinates (3D and orientation) and timestamp differentials which provides walking speed and/or based on data from the accelerometer. This can be monitored against normal X, Y, Z and orientation profiles of the individual animal. Such defined characteristics will elicit an alarm for attention to the individual animal.

A diseased or stressed animal will elicit an alarm based on datum coordinates (3D and orientation) and timestamp differentials against norms. E.g. an animal exhibiting signs of BSE, Mastitis, Foot & mouth and heat stress will exhibit signs that can be monitored in X, Y, Z profile and orientation. If set criteria are met then an alarm can be elicited for attention to individual animal.

Alarms/triggers based on above criteria may be linked to video-camera tracking for individual animal attention and remote surveillance. The animal may be provided with video or camera monitoring systems for providing a moving or still image of the animal's surroundings which may be transmitted from the animal's tag.

Alarms/triggers based on the above criteria may be linked to access/control sorting gates for attention to be made to an individual animal. For example, individual animal can be sorted for artificial insemination based on certain predetermined criteria and/or individual animal can be sorted for veterinary attention based on other predetermined criteria. Such gates may be virtual, being defined only in the computer model of the system.

Alarms/triggers can be linked via web-based applications for remote user interfaces (personal computers, mobile telephones or any other communication device.)

The XYZ and orientation datums of key systems incorporated into the pre-set CAD of the animals' environment or zone area provides data and access control of animal to system or zone areas.

Orientation datums provide data on the animals' positional direction to the systems or zone areas. If an animal is at the correct location, based on its tags three dimensional position, and is facing the right way, as determined by the tags orientation sending/detection device, then access control to the system or zone area is determined.

The system allows one to discriminate between the following activities: (a) an animal lying down, (b) an animal standing, (c) an animal mounting another animal, (d) an animal feeding, and (e) an animal at a water trough.

A tag may be associated with each moveable object within the monitoring zone such that an alarm or alert may be triggered based upon the proximity and/or orientation of an animal to such tagged objects.

A person entering the monitoring zone, such as a farmer or vet, may be provided with a tag so that the system can monitor and record the interaction between such persons and a tagged animal.

A portable tag reader may be provided for interrogating a tag of an animal to identify the animal and download information, for example logged information on the animal's activities or information from one or more biometric sensors associated with the animal. The reader may be provided with a tag to be identified by the system and/or may be provided with an orientation sensing device so that the device can be pointed at a particular animal to be investigated.

FIGS. 4 to 7 illustrate a tag housing for attaching a tag to an animal for use in an animal monitoring system according to the present invention.

The tag housing 100 comprises a saddle shaped housing shaped to fit against the back or neck of a cow against the spine of the animal to retain the tag on an upper portion of the cow's neck. The housing 100 defines a sleeve for receiving an elasticated strap (not shown) for securing the tag to the animal. The strap may be provided with a releasable fastener or buckle to allow the tag to be readily attached to and removed from the animal.

The housing 100 defines three distinct housing portions, an upper central housing portion 102 adapted to receive a radio transponder, preferably an Ultra-wide band transponder. First and second sides of the tag housing define first and second side housing portions 104,106, a first housing portion 104 housing one or more rechargeable batteries and a second housing portion 106 housing an orientation sensing device, such as a magneto-resistive field sensors and/or one or more accelerometers.

Reduced thickness portions 108 of the housing 100 between the respective first and second side housing portions 104,106 and the central housing portion 102 provide hinge portions allowing the sides of the tag housing 100 to flex to enable the tag housing 100 to be fitted to different sized animals.

The tag 18 may incorporate a device for stimulating the animal, for example via contact with the animal's skin, by en electrical stimulation or by any other means, such that the system may be used to modify and/or control the behavior of the animal, for example to deter the animal from entering a certain area or from crossing a predefined boundary within the monitoring zone or from carrying out a predetermined activity. Such stimulation may also be used to encourage the animal to carry out specific actions or to move in a certain direction or to a desired location.

The invention is not limited to the embodiment(s) described herein but can be amended or modified without departing from the scope of the present invention.

1. An animal monitoring system, said system comprising:
at least one tag attachable to an animal;
a real time location system (RTLS) for determining the three dimensional position of said at least one tag within a monitoring zone;
an orientation determining device for determining the three dimensional orientation of said at least one tag; and
a discriminating device for discriminating between different activities of the at least one animal by comparing the three dimensional location and three dimensional orientation of the animal's tag within the monitoring zone with at least one datum in a computer model of the monitoring zone.

2. A system as claimed in claim 1, further comprising a device for determining the rate of movement of the at least one tag as a vector.

3. (canceled)

4. A system as claimed in claim 1, wherein the location of the animal's tag and the datum in the computer model is defined in three-dimensions such that the monitoring system can determine the relative distance of the animal's tag from the datum in three dimensions.

5. A system as claimed in claim 4, wherein at least one datum corresponds to the position of a fixed object within the monitoring zone wherein at least one datum corresponds to a particular location or spatial position indicative of the activity of the animal, the activity comprising at least one chosen from standing, lying down, or feeding adjacent a food source.

6. (canceled)

7. A system as claimed in claim 1, wherein the system further discriminates between different activities of at least one animal by comparing the three dimensional location and three dimensional orientation or rate of movement of the animal's tag within the zone with the three dimensional location and three dimensional orientation or rate of movement of at least one further tag within the zone, said further tag being associated with a further animal or object within the monitoring zone, wherein the location of the animal's tag and the location of the one or more further animals and/or object's tags is defined in three-dimensions such that the monitoring system can determine the relative distance and orientation and/or rate of movement of the animal's tag from said at least one further animal's tag in three dimensions.

8-9. (canceled)

10. A system as claimed in claim 1, wherein the at least one tag comprises an active or passive radio frequency transponder and an orientation sensing/detection device, said RTLS comprising at least one radio frequency transceiver for detecting the location of the or each tag within the monitoring zone, wherein said RTLS comprises a plurality of radio frequency transceivers whereby the three dimensional location of said at least one tag can be determined by comparing the time taken for receipt of a signal from said at least one tag by at least three of said plurality of transceivers such that the location of the tag can be determined by triangulation techniques.

11. (canceled)

12. A system as claimed in claim 10, wherein the RTLS uses ultra-wideband radio frequency technology.

13. A system as claimed in claim 1, wherein the orientation determining device comprises one or more magneto-resistive field sensors or magneto-inductive sensors.

14. (canceled)

15. A system as claimed in claim 1, further comprising a three axis accelerometer for detecting, motion of the tag in three dimensions.

16. A system as claimed in claim 1, wherein the tag provides a unique identifier for uniquely identifying the animal to which it is attached or associated, with one or more biometric or environmental sensors for determining or monitoring the physical condition of the animal or the ambient conditions surrounding the animal.

17. A system as claimed in claim 1, wherein the determining device is programmed to trigger an alarm upon determination of a predetermined status or activity of a tagged animal, wherein said alarm identifies the tagged animal for which said status of activity is detected, the nature of the status/activity detected and/or the location of the animal.

18-19. (canceled)

20. A method of monitoring animals, said method comprising:
individually identifying and tracking the movements of tagged animals or objects in three dimensions within a monitoring zone; and
discriminating between different activities of at least one animal based upon the location in three dimensions and orientation in three dimensions of the animals' or objects' tags within the monitoring zone.

21. A tag for an animal monitoring system, said tag comprising:
a transponder for determining the three dimensional location of the tag in a monitoring zone; and
an orientation detection/sensing device for determining the orientation of the tag in three dimensions.

22. (canceled)

23. A tag as claimed in claim 21, wherein the tag comprises a collar attachable to the neck of an animal.

24. (canceled)

25. A tag as claimed in claim 21, wherein the transponder comprises an Ultra-wide band transponder.

26. A tag as claimed in claim 21, wherein the orientation detection/sensing device comprises one or more magneto-resistive field sensors or magneto-inductive sensors.

27-28. (canceled)

29. A tag as claimed in claim 21, wherein the tag incorporates a three axis accelerometer for detecting motion in three dimensions.

30. A tag as claimed in claim 21, further comprising a saddle shaped tag housing shaped to be locatable on a spine region of the animal, and a strap for attaching the tag housing to the animal.

31-35. (canceled)

36. A tag as claimed in claim 30, wherein the tag housing comprises a central portion for housing the transponder, and first and second side portions located on either side of said central portion, wherein at least one of said first and second side portions houses one or more batteries or the orientation determining/sensing device.

37. A tag as claimed in claim 36, wherein hinge portions are defined between the respective first and second side portions and the central portion of the housing to allow the housing to be adjusted to fit different sized animals.

38-42. (canceled)
